(19) United States
(12) Patent Application Publication
(10) Pub. No.: US 2025/0295477 A1
(43) Pub. Date: Sep. 25, 2025

(54) SYSTEMS AND METHODS FOR SUPPRESSING VIBRATION CAUSED BY DENTAL DRILLING PROCEDURES

(71) Applicant: The Johns Hopkins University, Baltimore, MD (US)

(72) Inventors: Jordan Rigsby, Tallahassee, FL (US); Conor Miguel Allan, Baltimore, MD (US); Elizabeth Dolan, Baltimore, MD (US); David Joonwon Paik, Baltimore, MD (US); Daniel Shenkelman, Baltimore, MD (US); Stephen M. Belkoff, Baldwin, MD (US); Rich Bauernschub, Baltimore, MD (US); Yensabro Kanashiro, Bamtimore, MD (US)

(21) Appl. No.: 19/085,746

(22) Filed: Mar. 20, 2025

Related U.S. Application Data
(60) Provisional application No. 63/567,763, filed on Mar. 20, 2024.

(51) Int. Cl. A61C 1/00; A61C 3/03; A61C 5/90; A61C 19/04; G10K 11/175

(52) U.S. Cl. CPC A61C 1/0015; A61C 3/03; A61C 5/90; A61C 19/04; G10K 11/175

(57) ABSTRACT

Systems and methods for mitigating noise during a dental procedure are provided. The system may comprise one or more sensors configured to sense one or more vibrations within a skull (e.g mouth and/or proximate to ear) of a patient and convert the one or more vibrations into an electrical signal, a control box, comprising a processor and a memory, configured to invert the electrical signal, generating an inverted electrical signal and transmit the inverted electrical signal to a conduction sound generator, and the conduction sound generator, configured to receive the inverted electrical signal and output conduction sound to the skull of the patient, causing destructive interference with the one or more vibrations within the skull of the patient.

### CROSS-REFERENCE TO RELATED APPLICATION

This application claims under 35 U.S.C. § 119(e) the benefit of U.S. Provisional Application No: 63/567,763, filed Mar. 20, 2024, the entire contents of which are incorporated by reference herein.

### TECHNICAL FIELD

The disclosed embodiments relate generally to systems, methods, and devices for suppressing vibrations caused during dental procedures.

### BACKGROUND

Oral hygiene is vital to a person's overall health and well-being. Sound generated by dental equipment—be it acoustic sounds or vibration sounds—can cause anxiety and fear in some patients and dental professionals and contribute to patients avoiding dental visits.

While dental handpieces have become increasingly quieter over the years, noise to the patient has not been negated due to bone conduction via teeth and mandible. During a dental procedure, sound is conducted as subtle vibration along the bones (e.g., via the teeth and mandible) to the inner ear, allowing the listener to perceive noise without blocking the ear canal. Noise cancelation headphones cannot mitigate bone conduction because, in noise cancelation, the noise and the reverse sound waves of the noise, are both received by the ears through the ear canal, whereas, for bone conduction, sound is conducted along the bones and not the ear canal.

Accordingly, there is a need for improved systems, methods, and devices that mitigate noise transmitted via bone conduction during a dental procedure.

### SUMMARY

According to an object of the present disclosure, a system for mitigating noise during a dental procedure is provided. The system may comprise one or more sensors configured to sense one or more vibrations within a skull of a patient (e.g. within the mouth of a patient) of a patient and convert the one or more vibrations into an electrical signal, a control box, comprising a processor and a memory, configured to invert the electrical signal, generating an inverted electrical signal and transmit the inverted electrical signal to a conduction sound generator, and the conduction sound generator, configured to receive the inverted electrical signal and output conduction sound to the skull of the patient, causing destructive interference with the one or more vibrations within the skull of the patient.

According to an exemplary embodiment, the one or more sensors may comprise an accelerometer.

According to an exemplary embodiment, the conduction sound generator may comprise conduction headphones.

According to an exemplary embodiment, the one or more sensors may be configured to transmit the electrical signal to the control box.

According to an exemplary embodiment, the one or more sensors may be positioned within a bite block configured to be inserted within the skull of the patient.

According to an exemplary embodiment, the one or more sensors may be coupled to a handpiece of a dental drill.

According to an object of the present disclosure, a method for mitigating noise during a dental procedure is provided. The method may comprise, using one or more sensors, sensing one or more vibrations within a skull of a patient (e.g. within the mouth of a patient) and converting the one or more vibrations into an electrical signal. The method may comprise, using a control box, comprising a processor and a memory, inverting the electrical signal, generating an inverted electrical signal, and transmitting the inverted electrical signal to a conduction sound generator. The method may comprise, using the conduction sound generator, receiving the inverted electrical signal, and outputting conduction sound to the skull of the patient, causing destructive interference with the one or more vibrations within the skull of the patient.

According to an exemplary embodiment, the one or more sensors may comprise an accelerometer.

According to an exemplary embodiment, the conduction sound generator may comprise conduction headphones.

According to an exemplary embodiment, the method may further comprise, using the one or more sensors, transmitting the electrical signal to the control box.

According to an exemplary embodiment, the one or more sensors may be positioned within a bite block configured to be inserted within the skull of the patient (e.g. within the mouth of a patient).

According to an exemplary embodiment, the one or more sensors may be coupled to a handpiece of a dental drill.

In accordance with some implementations, an apparatus for mitigating noise during dental procedures includes a vibration unit configured to generate second vibrations. The apparatus includes a bite block that is physically connected to the vibration unit. The bite block is configured to contact at least one tooth of a patient. The bite block is configured to transmit the second vibrations generated by the vibration unit during the dental procedure. The second vibrations at least partially offset vibrations generated by a dental tool during a dental procedure.

### BRIEF DESCRIPTION OF THE DRAWINGS

The patent or application file contains at least one drawing executed in color. Copies of this patent or patent application publication with color drawings will be provided by the Office upon request and payment of the necessary fee.

The disclosed aspects will hereinafter be described in conjunction with the appended drawings, provided to illustrate and not to limit the disclosed aspects. Like designations denote like elements.

FIG. 1 illustrates an example noise-cancelling system, according to an exemplary embodiment of the present disclosure.

FIG. 2 illustrates example bone conduction headphones, according to an exemplary embodiment of the present disclosure.

FIG. 3 illustrates example bone conduction headphones in use, according to an exemplary embodiment of the present disclosure.

FIG. 4 illustrates the principle of active noise cancelling.

FIG. 5 illustrates an example circuit board coupled to a mouth prop/bite block of a noise cancelling system, according to an exemplary embodiment of the present disclosure.

FIG. 6 illustrates a front view of a circuit board comprising an accelerometer, according to an exemplary embodiment of the present disclosure.

FIG. 7 illustrates a back view of the circuit board of FIG. 6, according to an exemplary embodiment of the present disclosure.

FIG. 8 is a flowchart of a method for suppressing vibration caused by dental drilling procedures, according to an exemplary embodiment of the present disclosure.

FIG. 9A illustrates a bite block, according to an exemplary embodiment of the present disclosure.

FIG. 9B illustrates a bite block that is inserted into a patient's mouth, according to an exemplary embodiment of the present disclosure.

FIG. 10A illustrates an apparatus that includes a bite block and a vibration unit, according to an exemplary embodiment of the present disclosure.

FIG. 10B illustrates communicative coupling between the apparatus of FIG. 2A and an audio device, according to an exemplary embodiment of the present disclosure.

FIG. 11 is a block diagram of an apparatus, according to an exemplary embodiment of the present disclosure.

FIG. 12 illustrates example elements of a computing device, according to an exemplary embodiment of the present disclosure.

Reference will now be made to embodiments, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

According to exemplary embodiments, systems and methods for sound mitigation during a dental procedure are provided.

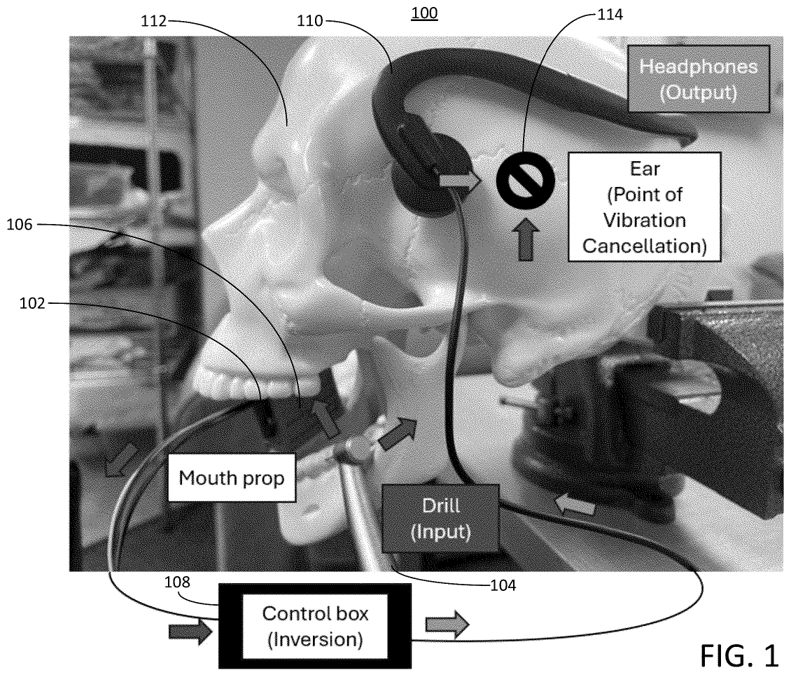

FIG. 1 illustrates an example noise-cancelling system 100, in accordance with an exemplary embodiment of the present disclosure.

According to an exemplary embodiment, the noise-cancelling system 100 may comprise one or more sensors 102, a control box 108, and a conduction sound generator 110.

As shown in FIG. 1, the mouth prop/bite block 106 and the conduction sound generator 110 are positioned on a model of a human skull 112. According to an exemplary embodiment, a drill 104 inputs vibration through the skull bone 112. This vibration signal may be conducted to the sensor 102 and measured by an accelerometer 118 (as shown, e.g., in FIG. 6) and sent to the control box 108 (see arrows in red). According to an exemplary embodiment, the sensor 102 may be coupled to the mouth prop/bite block 106. It is noted, however, that the sensor 102 may be positioned in one or more other suitable locations.

According to an exemplary embodiment, the sensor 102 may be configured to measure vibration caused by dental drilling (via, e.g., dental drill 104). According to an exemplary embodiment, the sensor 102 may be located on the dental drill 104, in a mouth prop/bite block 106, and/or other suitable location configured to sense the vibration. According to an exemplary embodiment, the sensor 102 may be configured to transduce the vibration caused by drilling to a signal (e.g., an electrical signal). According to an exemplary embodiment, the noise-cancelling system 100 may be configured to transmit the electrical signal to an electrical circuit or to some other suitable mechanism for processing (e.g., the control box 108).

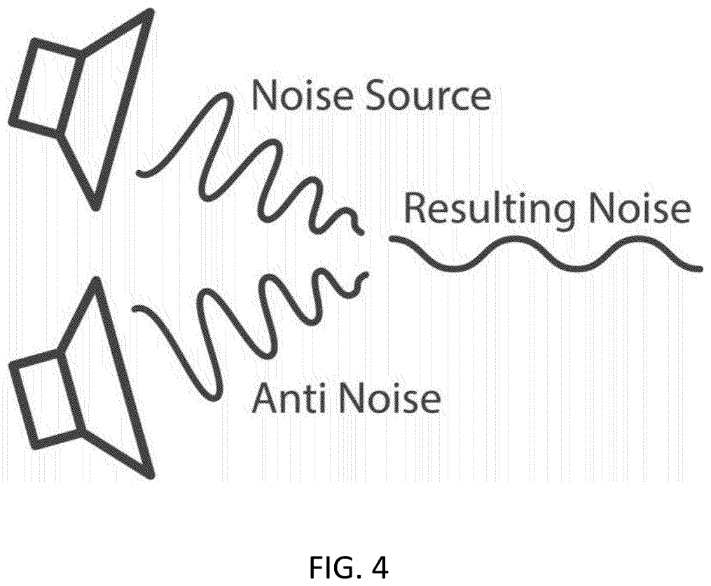

According to an exemplary embodiment, the control box 108 may comprise a computing device comprising a processor and/or a memory. According to an exemplary embodiment, the processor inside the control box may be configured to invert the electrical signal and send the inverted electrical signal to the conduction sound generator 110 on the skull 112 (see arrows in blue). The conduction sound generator 110 may then output conduction sound through the skull 112 in accordance with the inverted electrical signal. The output conduction sound may be in the form of transmitted mechanical vibration. According to an exemplary embodiment, the mechanical vibration may be designed to destructively interfere with the source vibration from the dental drill 104 conducted through the skull 112. According to an exemplary embodiment, the destructive interference may be configured to reduce perceived drilling noise by at least 10%, resulting in the reduction of the vibration signal felt by a patient. As shown, e.g., in FIG. 4, destructive interference may occur when a noise source and an anti-noise source (e.g., two opposite sinusoidal waves) summed together result in a single sound wave with peaks and valleys close to zero.

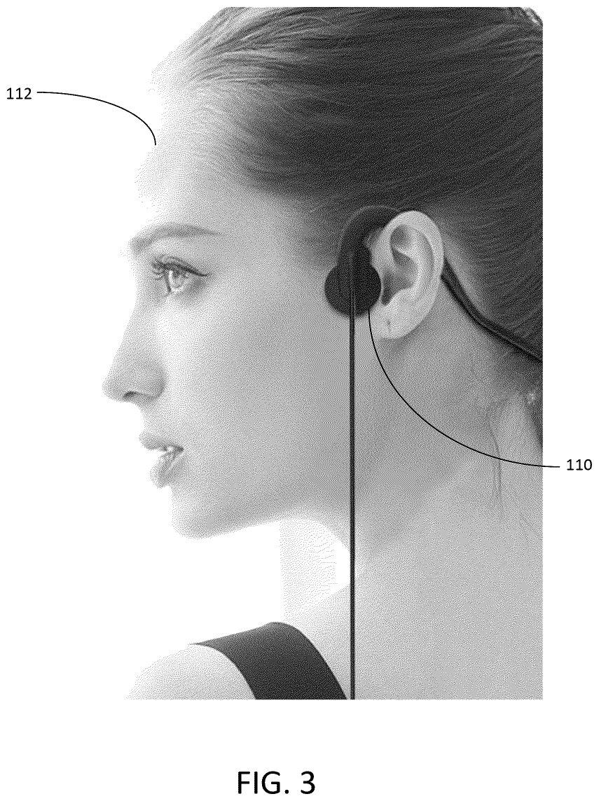

According to an exemplary embodiment, the conduction sound generator 110 comprises conduction headphones (as shown, e.g., in FIGS. 1-3). It is noted, however, that other suitable conduction sound generators may be incorporated, while maintaining the spirit and functionality of the present disclosure.

According to an exemplary embodiment, the input vibration signal from the drill 104, transmitted through the skull 112, and the inverted vibration signal, outputted from the conduction sound generator 110, meet at the car part 114 of the skull 112, resulting in the cancellation of the two opposite signals.

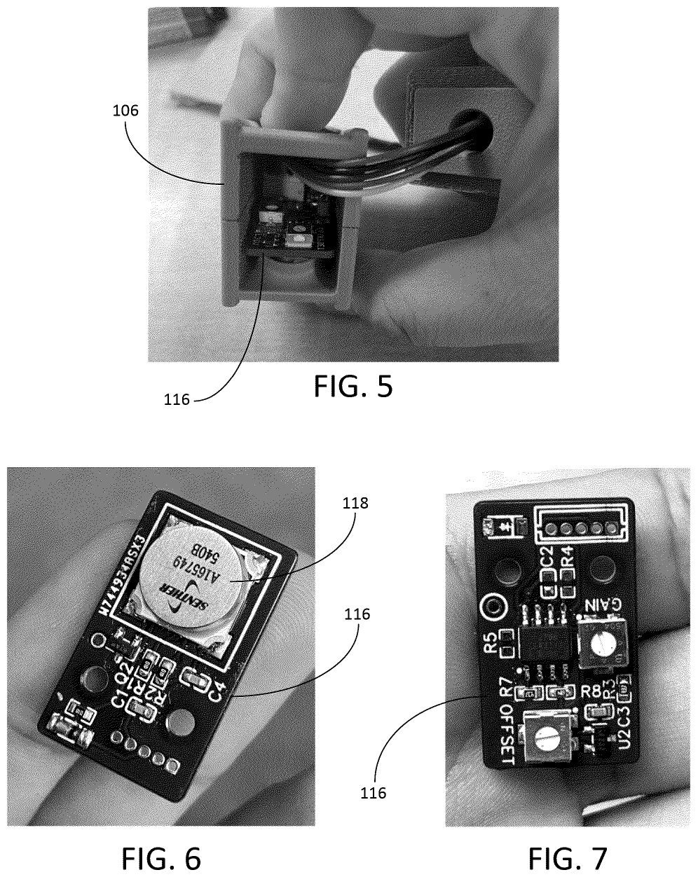

According to an exemplary embodiment, the mouth prop/bite block 106 may comprise an embedded circuit board 116 (as shown, e.g., in FIGS. 5-7). It is noted, however, that the circuit board 116 may, alternatively, be coupled to one or more other suitable components and/or may be independent. The circuit board 116 may be inserted into the dental patient's mouth. The vibration signals from a dental drill 104 in contact with the patient's teeth conduct through the teeth and jaw and are detected by an accelerometer 118 (as shown, e.g., in FIG. 6). According to an exemplary embodiment, the vibrations may be sensed at the dental drill handpiece (e.g., the one or more sensors 102 may be coupled and/or within the handpiece of the drill 104), and/or other suitable location. According to an exemplary embodiment, the one or more sensors 102 may comprise the circuit board 116 and/or the accelerometer 118.

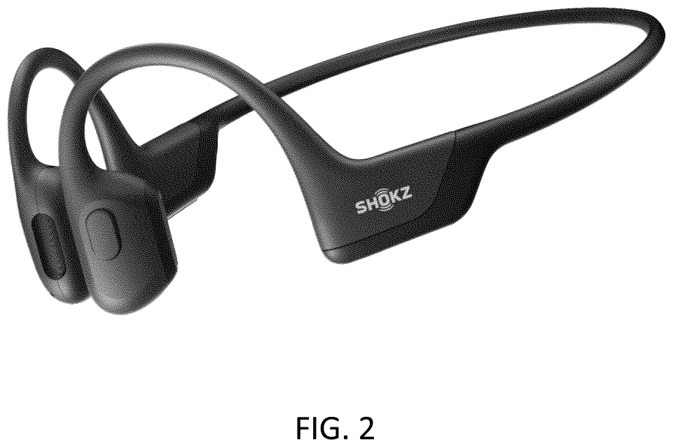

According to an exemplary embodiment, all connections between components may be wired and/or wireless (e.g., wireless connection using wireless conduction headphones 110 as shown, e.g., in FIG. 2, which enables a wireless connection between the control box 108 and the wireless bone conduction headphones 110.

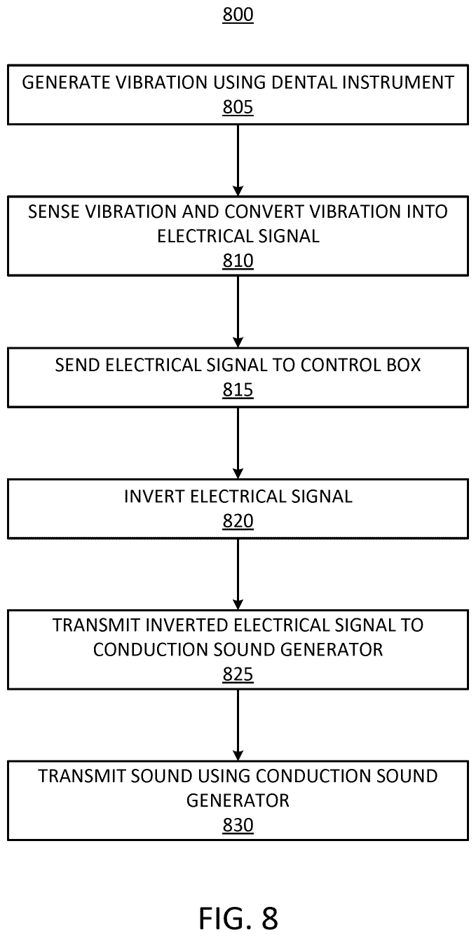

FIG. 8 illustrates a flowchart of a method 800 for suppressing vibration caused by dental drilling procedures, in accordance with an exemplary embodiment of the present disclosure.

At 805, a dental instrument (e.g., a drill) may generate a vibration whereby the vibration may be input through the skull bone. At 810, this vibration signal is conducted to the sensor and measured by an accelerometer and sent to the control box. According to an exemplary embodiment, the sensor may be configured to measure the vibration caused by dental drilling and transduce the vibration caused by drilling to a signal (e.g., an electrical signal).

At 815, the noise-cancelling system may be configured to transmit the electrical signal to an electrical circuit or to some other suitable mechanism for processing (e.g., the control box). According to an exemplary embodiment, the control box may comprise a computing device comprising a processor and/or a memory. At 820, the processor inside the control box may be configured to invert the electrical signal and, at 825, send/transmit the inverted electrical signal to the conduction sound generator.

At 830, the conduction sound generator may output conduction sound through the skull in accordance with the inverted electrical signal. The output conduction sound may be in the form of transmitted mechanical vibration. According to an exemplary embodiment, the mechanical vibration may be designed to destructively interfere with the source vibration from the dental drill conducted through the skull.

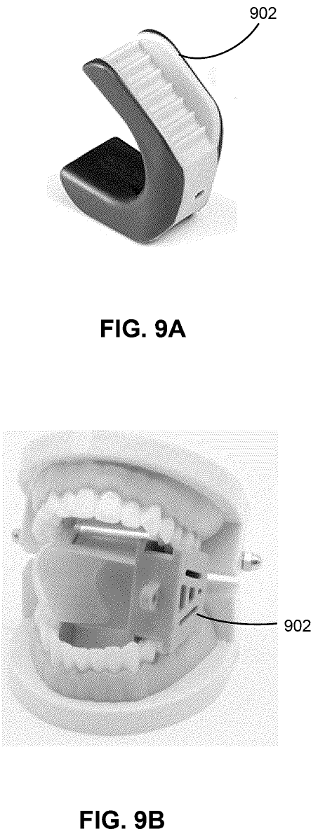

FIG. 9A illustrates a bite block 902 (e.g., a dental block) that is used in a dental procedure, in accordance with an exemplary embodiment of the present disclosure. FIG. 9B illustrates the bite block 902 of FIG. 9A when it is inserted into a patient's mouth during a dental procedure, in accordance with an exemplary embodiment of the present disclosure.

According to an exemplary embodiment, the bite block 902 may be configured to enable patients to rest their teeth instead of holding their mouths open during the dental procedure. According to an exemplary embodiment, the bite block 902 may comprise a material that is stainless steel, Nickel-Titanium, ceramic, composite, and/or plastic.

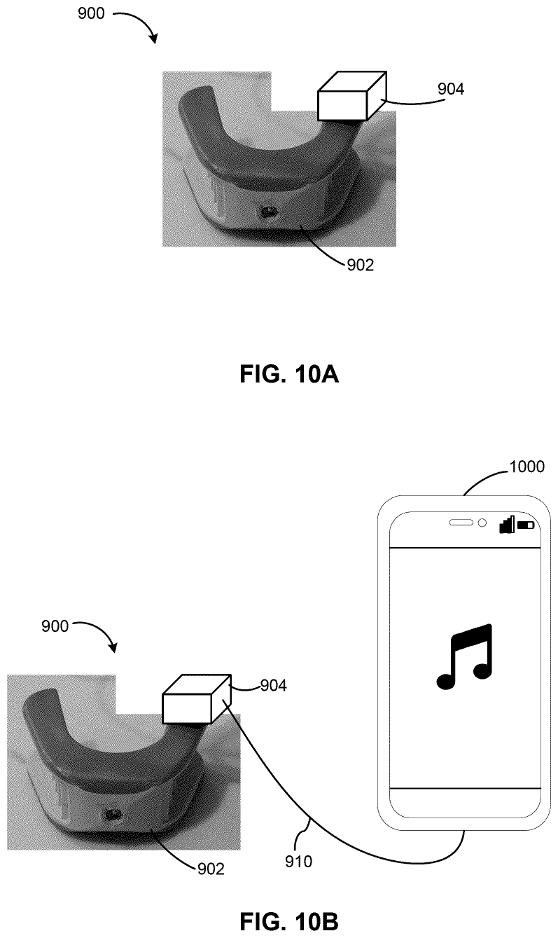

FIG. 10A illustrates an apparatus 900 that comprises a bite block 902 and a vibration unit 904, according to an exemplary embodiment of the present disclosure. FIG. 10A illustrates the bite block 902 coupled to (e.g., physically connected with) the vibration unit 904, in accordance with an exemplary embodiment of the present disclosure. According to exemplary embodiments of the present disclosure, the vibration unit 904 may affixed to, mounted onto, at least partially embedded in, and/or at least partially inserted into, the bite block 902. According to an exemplary embodiment, the bite block 902 may be detachably connected to the vibration unit 904. The vibration unit 904 may be configured, at the end of a dental procedure, to be removed from the bite block 902 to facilitate autoclaving/sterilization of the bite block 902.

According to an exemplary embodiment, the vibration unit 904 may be configured to generate vibrations during a dental procedure. According to an exemplary embodiment, the vibration unit 904 may comprise a motor. According to an exemplary embodiment, the motor may comprise a shaft that touches the bite block 902. According to an exemplary embodiment, the motor may comprise a direct current (DC) motor comprising a shaft that is placed into a hole of the bite block 902. According to an exemplary embodiment, as the shaft spins, the shaft may be configured to vibrate the bite block 902.

According to an exemplary embodiment, the vibration unit 904 may comprise an actuator (e.g., a linear actuator). In accordance with an exemplary embodiment of the present disclosure, the vibration unit 904 configured to generate second vibrations (e.g., during the dental procedure).

The bite block 902 may be configured to contact at least one tooth of a patient during the dental procedure. The bite block 902 may be configured to transmit second vibrations generated by the vibration unit 904 during the dental procedure. The second vibrations may be configured to at least partially offset (e.g., attenuate) the first vibrations generated by a dental tool during the dental procedure. According to an exemplary embodiment, the apparatus 900 may be configured to transmit the vibration to any area of the mandible and maxilla bone, not just the teeth of the patient.

FIG. 10B illustrates communicative coupling between the apparatus 900 of FIG. 10A and an electronic device 1000 according to some embodiments, in accordance with an exemplary embodiment of the present disclosure. According to an exemplary embodiment, the electronic device 1000 may be configured to output an audio signal (e.g., for music).

According to an exemplary embodiment, the bite block 902 may be configured to, during the dental procedure, conduct sound generated by the electronic device 1000. The sound may be configured to at least partially cancel (e.g., attenuate) sound generated by the dental tool.

FIG. 10B illustrates a cable 910 (e.g., a pair of wires) with one end that is attached to the vibration unit 904 and the other end that is plugged into an audio jack of the electronic device 1000. According to an exemplary embodiment, music corresponding to the audio signal from audio jack may be inaudible until the patient bites on the bite block 902.

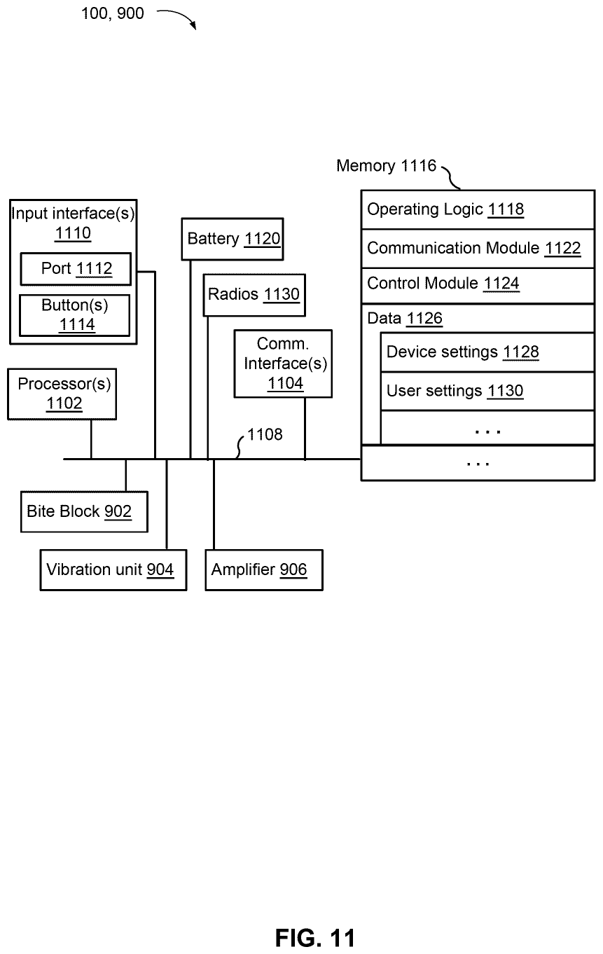

According to an exemplary embodiment, the apparatus 900 may be wirelessly connected to the electronic device 1000 (e.g., via one or more radios 1130, as shown in FIG. 11, and/or other suitable means).

According to an exemplary embodiment, the apparatus 900 may comprise one or more ear plugs (e.g., one or more simple plugs and/or active plugs that create sounds). According to an exemplary embodiment, during a dental procedure, an car plug may be inserted in a contralateral car of the patient to occlude an ear canal of the patient.

FIG. 11 is a block diagram of an apparatus (e.g., apparatus 100 or apparatus 900), in accordance with an exemplary embodiment of the present disclosure.

According to an exemplary embodiment, the apparatus 100, 900 may comprise a bite block 902, as described with respect to FIGS. 9A, 9B, 10A, and 10B. According to an exemplary embodiment, the apparatus 900 may comprise a vibration unit 904, as described with respect to FIGS. 9A, 9B, 10A, and 10B.

According to an exemplary embodiment, the apparatus 100, 900 may comprise an amplifier 906. The amplifier 906 may be configured to increase or decrease the vibration generated by the vibration unit 904.

According to an exemplary embodiment, the apparatus 900 may comprise one or more input interfaces 1110 configured to facilitate user input. For example, according to an exemplary embodiment, the input interfaces 1110 may comprise a port 1112 (e.g., a charging port or a USB port) and one or more buttons 1114. According to an exemplary embodiment, the apparatus 900 may comprise a battery 1120. According to an exemplary embodiment, the apparatus 900 may be battery-operated.

According to an exemplary embodiment, the apparatus 900 may comprise one or more radios 1130. The one or more radios 1130 may be configured to enable one or more communication networks and allow the apparatus 900 to communicate with one or more other devices, such as, e.g., the electronic device 1000 in FIG. 10B. According to an exemplary embodiment, the one or more radios 1130 may be capable of data communications using any of a variety of custom or standard wireless protocols (e.g., IEEE 802.15.4, Wi-Fi, ZigBee, 6LoWPAN, Thread, Z-Wave, Bluetooth Smart, ISA100.5A, WirelessHART, MiWi, Ultrawide Band (UWB), or software defined radio (SDR)), custom or standard wired protocols (e.g., Ethernet or HomePlug), and/or any other suitable communication protocol, including, but not limited to, communication protocols not yet developed as of the filing date of this document.

The memory 1116 may comprise high-speed random access memory, such as DRAM, SRAM, DDR RAM, or other random access solid state memory devices. According to an exemplary embodiment, the memory 1116 may comprise non-volatile memory, such as one or more magnetic disk storage devices, one or more optical disk storage devices, one or more flash memory devices, or one or more other non-volatile solid state storage devices. In some embodiments, the memory 1116 may comprise one or more storage devices remotely located from one or more processor(s) 1102. The memory 1116, or alternatively the non-volatile memory within the memory 1116, may comprise a non-transitory computer-readable storage medium. In some implementations, the memory 1116, or the non-transitory computer-readable storage medium of the memory 1116, may stores the following programs, modules, and/or data structures, or a subset or superset thereof:
operating logic 1118, including procedures for handling various basic system services and for performing hardware dependent tasks;
a communication module 1122 (e.g., a radio communication module), connecting to and communicating with other network devices (e.g., a local network, such as a router that provides Internet connectivity, networked storage devices, network routing devices, server systems, electronic device 1000, and/or other connected devices) coupled to one or more communication networks via the communication interfaces 1110 (e.g., wired or wireless);
a control module 1124, controlling the vibration unit 904 in accordance with audio signals obtained from an electronic device 1000; and.
data 1126, including device settings data 1128 and user settings data 1130.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 1116 may be configured to store a subset of the modules and data structures identified above. Furthermore, the memory 1116 may be configured to store additional modules or data structures not described above.

According to an exemplary embodiment, the vibration unit 904 may be communicatively connected (e.g., via a cable, such as the cable 910 in FIG. 10B, or wirelessly communicated, such as via the one or more radios 1130) to the electronic device 1000. In some instances, the vibration unit may be configured to generate the second vibrations in response to audio signals from the electronic device 1000 (e.g., corresponding to music playing).

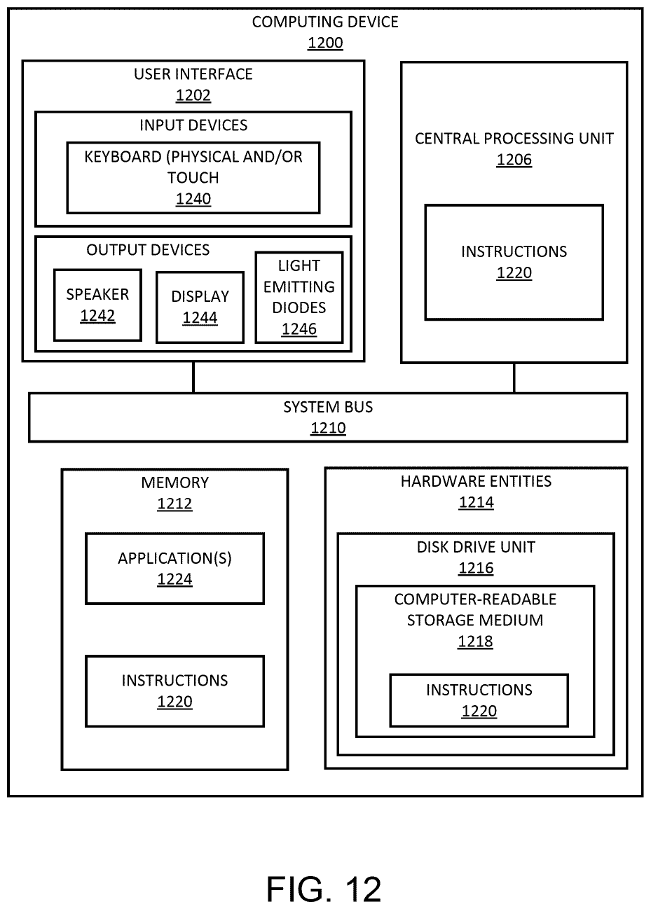

Referring now to FIG. 12, an illustration of an example architecture for a computing device 1200 is provided. According to an exemplary embodiment, one or more functions of the present disclosure may be implemented by a computing device such as, e.g., computing device 1200 or a computing device similar to computing device 1200. Computing device 1200 may be a quantum computer, a classical computer, and/or have one or more components configured to perform one or more quantum and/or classical computing functions. One or more components of apparatus 100 (e.g., control box 108) and/or apparatus 900 may be an example of computing device 1200 and/or may comprise one or more components of computing device 1200.

The hardware architecture of FIG. 12 represents one example implementation of a representative computing device configured to implement at least a portion of the systems/devices (e.g., apparatus 100, apparatus 900) and method(s)/control logic(s) (e.g., method 800) described herein.

Some or all components of the computing device 1200 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 12, the computing device 1200 may comprise a user interface 1202 (e.g., a graphical user interface), a Central Processing Unit (“CPU”) 1206, a system bus 1210, a memory 1212 connected to and accessible by other portions of computing device 1200 through system bus 1210, and hardware entities 1214 connected to system bus 1210. The user interface may comprise input devices and output devices, which may be configured to facilitate user-software interactions for controlling operations of the computing device 1200. The input devices may comprise, but are not limited to, a physical and/or touch keyboard 1240. The input devices may be connected to the computing device 1200 via a wired or wireless connection (e.g., a Bluetooth® connection). The output devices may comprise, but are not limited to, a speaker 1242, a display 1244, and/or light emitting diodes 1246.

At least some of the hardware entities 1214 may be configured to perform actions involving access to and use of memory 1212, which may be a Random Access Memory (RAM), a disk driver and/or a Compact Disc Read Only Memory (CD-ROM), among other suitable memory types. Hardware entities 1214 may comprise a disk drive unit 1216 comprising a computer-readable storage medium 1218 on which may be stored one or more sets of instructions 1220 (e.g., programming instructions such as, but not limited to, software code) configured to implement one or more of the methodologies, procedures, or functions described herein. The instructions 1220 may also reside, completely or at least partially, within the memory 1212 and/or within the CPU 1206 during execution thereof by the computing device 1200.

The memory 1212 and the CPU 1206 may also constitute machine-readable media. The term “machine-readable media”, as used here, refers to a single medium or multiple media (e.g., a centralized or distributed database, and/or associated caches and servers) that store the one or more sets of instructions 1220. The term “machine-readable media”, as used here, also refers to any medium that is capable of storing, encoding, or carrying a set of instructions 1220 for execution by the computing device 1200 and that cause the computing device 1200 to perform any one or more of the methodologies of the present disclosure. According to various embodiments, one or more computer applications 1224 may be stored on the memory 1212.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

1. A system for mitigating noise during a dental procedure, comprising:
one or more sensors configured to:
sense one or more vibrations within a skull of a patient; and
convert the one or more vibrations into an electrical signal;
a control box, comprising a processor and a memory, wherein the control box is configured to:
invert the electrical signal, generating an inverted electrical signal; and
transmit the inverted electrical signal to a conduction sound generator; and
the conduction sound generator, configured to:
receive the inverted electrical signal; and
output conduction sound to the skull of the patient, causing destructive interference with the one or more vibrations within the skull of the patient.

2. The system of claim 1, wherein the one or more sensors comprise an accelerometer.

3. The system of claim 1, wherein the conduction sound generator comprises conduction headphones.

4. The system of claim 1, wherein the one or more sensors are configured to transmit the electrical signal to the control box.

5. The system of claim 1, wherein the one or more sensors are positioned within a bite block configured to be inserted within the skull of the patient.

6. The system of claim 1, wherein the one or more sensors are coupled to a handpiece of a dental drill.

7. A method for mitigating noise during a dental procedure, comprising:
using one or more sensors:
sensing one or more vibrations within a skull of a patient; and
converting the one or more vibrations into an electrical signal;
using a control box, comprising a processor and a memory:
inverting the electrical signal, generating an inverted electrical signal; and
transmitting the inverted electrical signal to a conduction sound generator; and
using the conduction sound generator:
receiving the inverted electrical signal; and
outputting conduction sound to the skull of the patient, causing destructive interference with the one or more vibrations within the skull of the patient.

8. The method of claim 7, wherein the one or more sensors comprise an accelerometer.

9. The method of claim 7, wherein the conduction sound generator comprises conduction headphones.

10. The method of claim 7, further comprising, using the one or more sensors, transmitting the electrical signal to the control box.

11. The method of claim 7, wherein the one or more sensors are positioned within a bite block configured to be inserted within the skull of the patient.

12. The method of claim 7, wherein the one or more sensors are coupled to a handpiece of a dental drill.

13. An apparatus for mitigating noise during a dental procedure, comprising:
a vibration unit configured to generate second vibrations; and
a bite block physically connected to the vibration unit and configured to contact at least one tooth of a patient, the bite block configured to transmit second vibrations generated by the vibration unit during the dental procedure, wherein the second vibrations at least partially offset first vibrations generated by a dental tool during the dental procedure.

14. The apparatus of claim 13, wherein the vibration unit comprises a motor.

15. The apparatus of claim 14, wherein the motor comprises a shaft that is coupled to the bite block.

16. The apparatus of claim 13, wherein the vibration unit comprises an actuator.

17. The apparatus of claim 13, wherein the vibration unit is communicatively connected to an electronic device.

18. The apparatus of claim 17, wherein the vibration unit is configured to generate the second vibrations in response to sound playing on the electronic device.

19. The apparatus of claim 18, wherein the bite block is configured to, during the dental procedure:
conduct first sounds generated by the electronic device, wherein the first sounds at least partially cancel sounds generated by the dental tool.

20. The apparatus of claim 13, wherein the bite block is detachably connected to the vibration unit.

21-25. (canceled)
